(19) United States
(12) Patent Application Publication
(10) Pub. No.: US 2008/0243835 A1
(43) Pub. Date: Oct. 2, 2008

(54) PROGRAM, METHOD AND APPARATUS FOR WEB PAGE SEARCH

(75) Inventor: Hiroyuki Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/050,591

(22) Filed: Mar. 18, 2008

(30) Foreign Application Priority Data
Mar. 28, 2007 (JP) 2007-85738

(51) Int. Cl. G06F 17/30

(52) U.S. Cl. 707/5; 707/E17.014

(57) ABSTRACT

A web page searching method searches web pages publicized on a network by web servers. A computer performs the method by:
searching and extracting from the pages being searched, a web page associated with a searching keyword which is a searching condition inputted, based on the keyword; and
prioritizing by referring to access log files which are stored in the web server corresponding to the extracted web page and recording, for every user accessing, information about which page's link is accessed by the user, tallying for each link access to the web page to calculate an access frequency, determining a priority of the extracted web page for display by considering the calculated access frequency, and assigning the determined priority. Recent activity can be weighted more heavily than older activity, if desired.

### BACKGROUND OF THE INVENTION

1. Field of the Invention

The present invention relates to a program, method and apparatus for searching web pages stored in a web server for being searched. More specifically, the present invention relates to improvement in prioritizing a plurality of web pages extracted by the searching.

2. Description of the Related Art

Search engines are often used when, for example, web pages on Internet are searched. A search engine searches index data extracted from web pages on a web server based on a client-inputted keyword representing searching condition, prioritizes (ranks) the resultant web pages which meet the searching condition, and notifies the client of the web pages with their priorities with a list or other indication of the web pages in order of priority on a screen of the client.

Conventionally, the following four methods are mainly known as ways for calculating a score of priority.

Method 1. Using Contents of Data

For example, calculating the score of priority based on a frequency of appearance, an appearance position or distribution information of a searching keyword in data.

Method 2. Using Attribute Information of Data

For example, calculating the score of priority based on a file type or a file creator name.

Method 3. Using a Link Relationship between Web Pages

For example, calculating the score of priority based on the number of other web pages linked to the page, and reliability or a degree of importance of the link source page. It is based on the concept that a page linked from a large number of other pages contains information with a high degree of importance.

Method 4. Using an Access Frequency in a Display List of Search Result

A search engine records which data among a display list of search result is accessed. The higher the data of access frequency, the higher score of priority the data is assigned.

For Internet searching, in particular, a greater emphasis is being placed on the above methods 3 and 4, for displaying search results in order of preference of users who make search requests.

### SUMMARY OF THE INVENTION

However, sufficient reliability cannot be ensured since the determination of priority according to the above method 3 does not involve dynamic information such as which link will be accessed next by the user who browses web pages. For example, the method 3 does not take into consideration the case of a link which has been displayed with a high frequency but which users have not actually used to access linked sites therefrom, which may mean low priority for the user. Also not taken into consideration is the case where the priority should be evaluated in accordance with temporal properties such as the date and time when the search is requested because the frequency of accessing through the link to linked sites therefrom varies in accordance with the temporal properties.

For precise determination of the priority, it is desirable to consider the link between web pages like in the method 3. However, not the link between web pages but only the access frequency of the data of the web page alone is taken into consideration and therefore there is no accuracy increase of the priority calculation in the method 4.

The present invention is made in view of the above mentioned conventional technical problem and has an object to provide a program, method and apparatus for searching web pages which can determine reasonably appropriate and accurate priority with consideration of dynamic information such as which link will actually be followed by the user who browses web pages.

According to an aspect of an embodiment, a web page searching method searches web pages publicized on a network by web servers. A computer performs the method by:

searching and extracting from the pages being searched, a web page associated with a searching keyword which is a searching condition inputted, based on the keyword; and

prioritizing by referring to access log files which are stored in the web server corresponding to the extracted web page and recording, for every user accessing, information about which page's link is accessed by the user, tallying for each link access to the web page to calculate an access frequency, determining a priority of the extracted web page for display by considering the calculated access frequency, and assigning the determined priority. Recent activity can be weighted more heavily than older activity, if desired.

### BRIEF DESCRIPTION OF THE DRAWINGS

FIG. 1 is a block diagram illustrating a computer network including a web page searching apparatus according to an embodiment of the present invention;

FIG. 2 is a flowchart illustrating an access process according to the web page searching apparatus of FIG. 1;

FIG. 3 is a flowchart illustrating a period setting process according to the web page searching apparatus of FIG. 1;

FIG. 4 is a flowchart illustrating a first half of a data acquisition process according to the web page searching apparatus of FIG. 1;

FIG. 5 is a flowchart illustrating a second half of the data acquisition process according to the web page searching apparatus of FIG. 1;

FIG. 6 is a flowchart illustrating a searching process according to the web page searching apparatus of FIG. 1;

FIG. 7 is an illustration of an example of an index table generated by the web page searching apparatus of FIG. 1;

FIG. 8 is an illustration of an example of a link information table generated by the web page searching apparatus of FIG. 1; and

FIG. 9 is an illustration of another example of the link information table generated by the web page searching apparatus of FIG. 1.

### DETAILED DESCRIPTION OF THE PREFERRED EMBODIMENTS

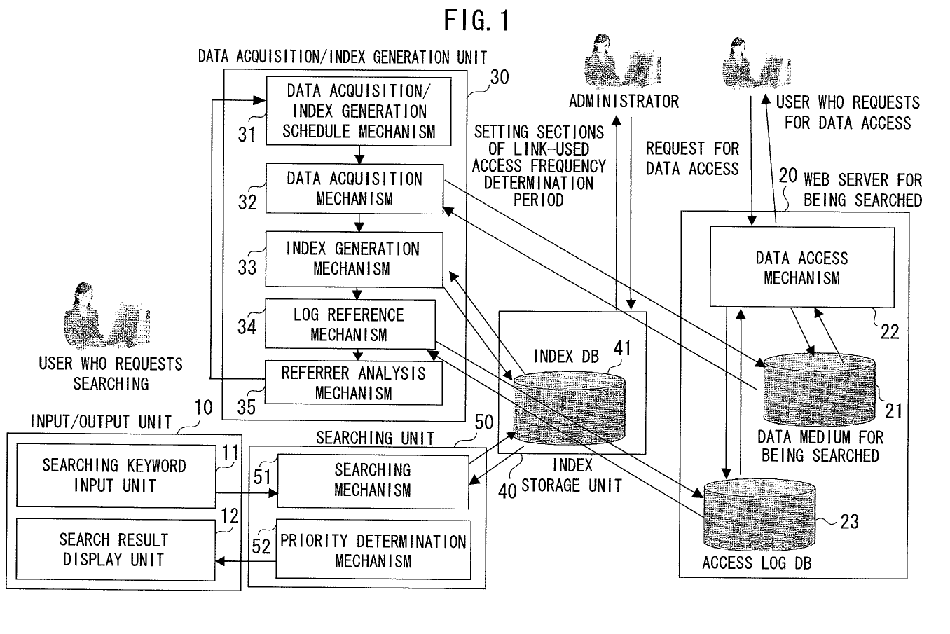

An embodiment of a web page searching apparatus of the present invention will be described hereinafter. FIG. 1 is a block diagram illustrating a configuration of a computer network including the web page searching apparatus according to the embodiment. This network includes: an input/output unit 10 which is operated by a user who makes a search request; a web server 20 for being searched when accessed by a user who requests data access, the web server storing data files of web pages for being searched; a data acquisition/index generation unit 30 which acquires data stored on the web server 20 and generates an index for search; an index storage unit 40 which is controlled by an administrator and stores the generated index; and a searching unit 50 which searches the files based on the index information stored in the index storage unit 40 when the input/output unit 10 requests searching.

The input/output unit 10 includes: a searching keyword input unit 11 which sends a keyword input by the user who makes the search request to the searching unit 50 and makes the searching unit 50 execute search of the keyword; and a search result display unit 12 which shows a search result returned from the searching unit 50 to the user.

The web server 20 includes: a data medium 21 which stores data files of web pages for being searched, the web page being publicized on a network; a data access mechanism 22 which controls accesses to a web page; and an access log DB 23 which records access logs to the web page. The access log DB 23 corresponds to an access log file that records access information about which page's link is used to access the web page by a user every time he/she accesses.

The data acquisition/index generation unit 30 has: a data acquisition/index generation schedule mechanism 31 which manages schedules of data acquisition and index generation; a data acquisition mechanism 32 which acquires data stored on the data medium 21 in accordance with the schedules; an index generation mechanism 33 which translates the acquired data into text files and generates indexes with a well-known approach such as a morphological analysis or a n-gram system; a log reference mechanism 34 which references the access log DB 23; and a referrer analysis mechanism 35 which appends an access frequency to the index generated by analyzing referrers included in the access log.

The index storage unit 40 includes: an index table which records the generated indexes; and an index DB 41 which has a link information table which records the access frequency.

The searching unit 50 includes: a searching mechanism 51 which searches the index DB 41 based on the keyword sent from the searching keyword input unit 11 of the input/output unit 10; and a priority determination mechanism 52 which determines the priority for a plurality of web pages extracted from the result of searching based on the read out information of each page such as the link information and the access frequency that the link is followed from the index DB 41.

In the above configuration, the input/output unit 10 and the searching mechanism 51 of the searching unit 50 correspond to searching means, and the data acquisition/index generation unit 30 and the priority determination mechanism 52 of the searching unit 50 correspond to priority determination means.

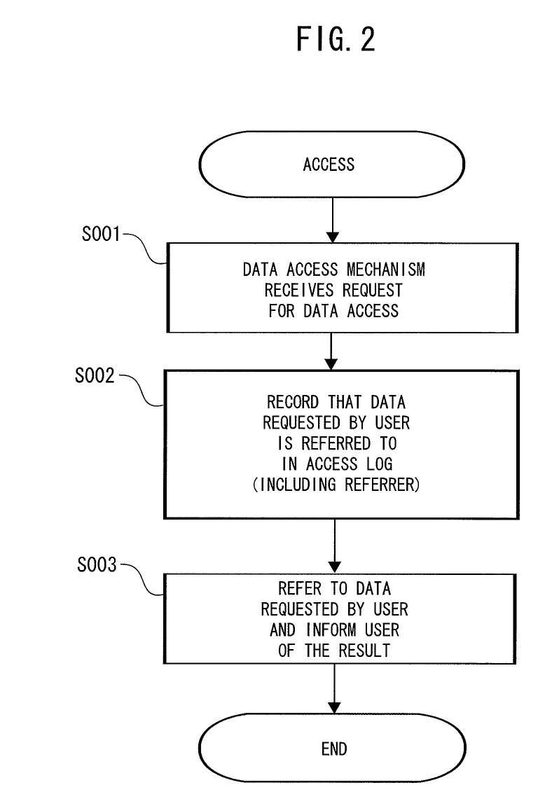

Network operations in the embodiment configured as above will be explained based on the flowchart shown in FIG. 2. It is assumed that data files of five web pages shown in Table 1 below are stored on the data medium 21.

TABLE 1

| | | Link | |
|---|---|---|---|
| URL of the Web page | entries | site | Web page |
| www.aaa.com/doc1.html | 0 | 1, 2 | In search of the |
| | | | document of a |
| | | | company . . . |
| www.bbb.com/doc2.html | 1 | 2, 3, 4 | The search |
| | | | engine of a |
| | | | picture . . . |
| www.ccc.com/doc3.html | 2 | — | Search of the |
| | | | source code of a |
| | | | system program . . . |
| www.ddd.com/doc4.html | 3 | — | Search of the |
| | | | data of a system |
| | | | program . . . |
| www.eee.com/doc5.html | 4 | — | A system is . . . |

FIG. 2 is a flowchart illustrating an access process to the web server 20 by the user who requests data access. In this process, the data access mechanism 22 receives an access from the user in a step S001, and the access log DB 23 records that access to the data requested from the user is made, in a step S002. The access log DB 23 records access information including which page's link is followed by the user to access the web page, which link of the web page is followed to access another web page, or the like.

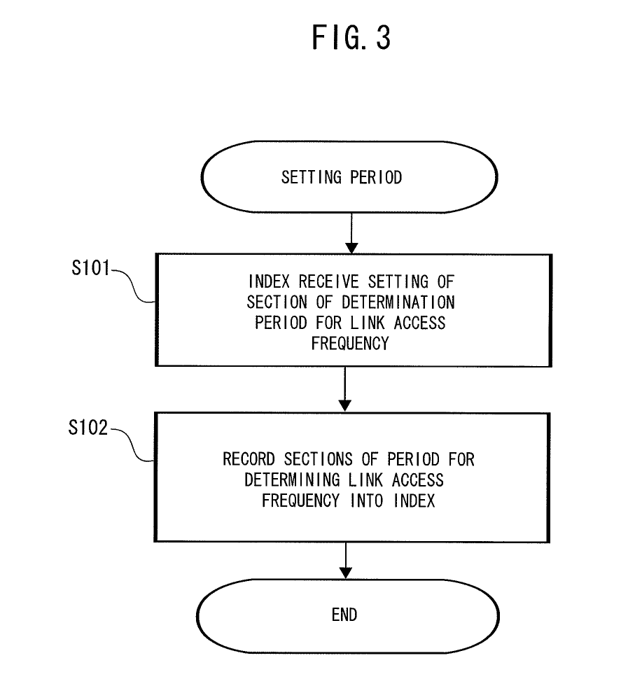

FIG. 3 is a flowchart illustrating procedure of a period setting process to set a period for recording access frequencies to links. In this process, the administrator accesses the index storage unit 40 to set the period. The index storage unit 40 receives a setting of sections of the determination period in a step S101, and sets sections of the period for determining the frequencies that access to the index DB 41 is made using the links, in a step S102.

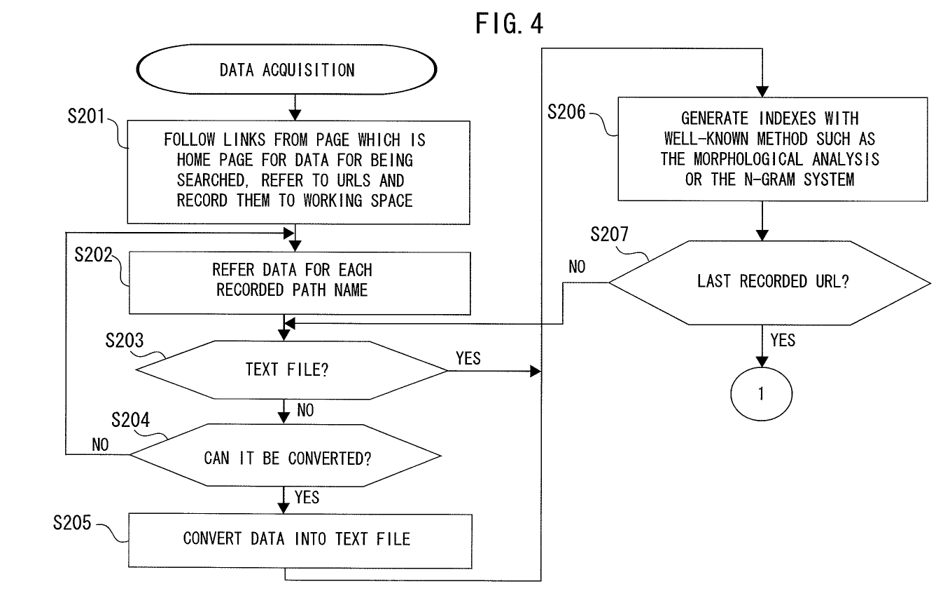

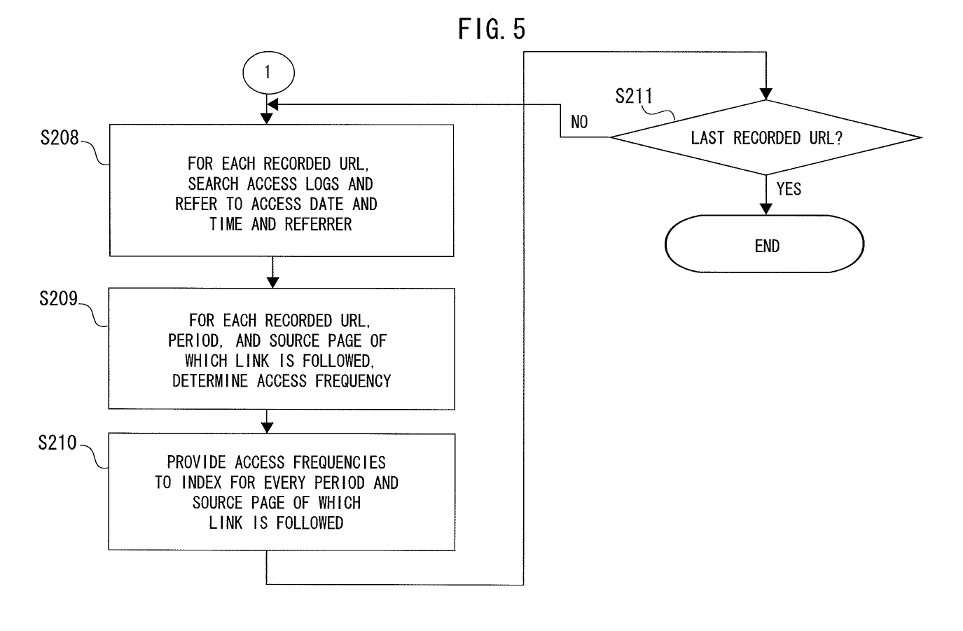

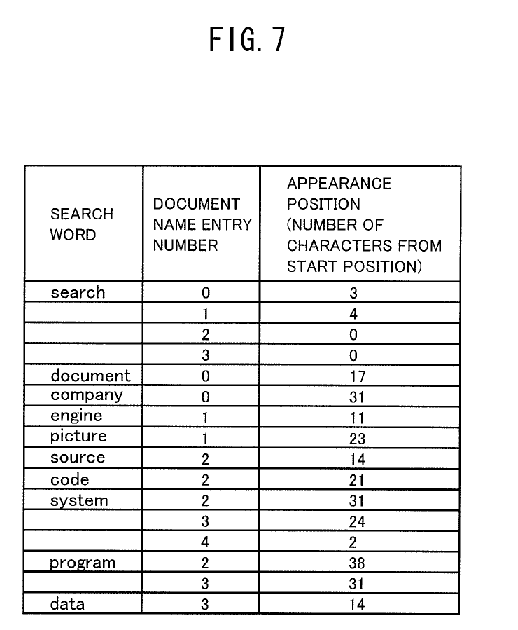

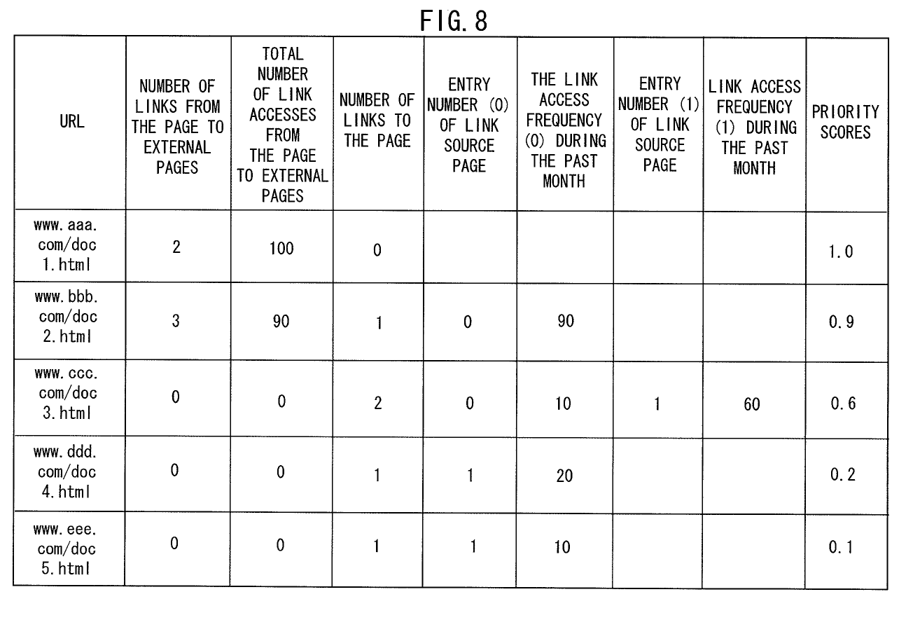

FIGS. 4 and 5 illustrate a data acquisition process for generating indexes for searching. In this process, data files of the web pages registered in the data medium 21 of the web server 20 are received, and analyzed for extracting keywords. The keywords are then registered in the index table shown in FIG. 7, and the access logs registered in the access log DB 23 are analyzed and registered in the link information table shown in FIG. 8.

In the first step S201 (FIG. 4) of the data acquisition process, links of the web page serving as a home page in the data medium 21 of the web server 20 are followed, and the URLs of all the web pages linked are referred to and recorded to a working space. Data for each page is referred to for each recorded URL (S202), and if the data is a text file, then the process directly proceeds to a step S206. If the data is not a text file, then the data is, if possible, converted into a text file (S203, S204 and S205) and the process proceeds to the step S206.

In the step S206, indexes are generated by extracting searching words (keywords) from the data files with well-known approaches such as the morphological analysis or the n-gram system. Steps S202 to S206 are repeatedly executed until all of the recorded URLs are processed in the same manner (until the determination of a step S207 indicates “Y”).

When the determination of the step S207 indicates “Y”, the process proceeds to a step S208 shown in FIG. 5. In the step S208, an access log is searched from the access log DB 23 for each web page of the recorded URL, and the access dates and time and the referrers in the log are referred to. Access frequencies are determined for every URL, period, and page of which link is followed, in a step S209.

There is shown herein below an example of a log format including a referrer. {10.0.51.101 - -[25/Dec/2006:17:30:05+0900] “GET/doc3.html HTTP/1.1” 200 100 “http://www.aaa.com/doc1.html” “Mozilla/4.0 (compatible; MSIE 6.0; Windows(R) NT 5.1)”}

Each information is arranged in the following order: a host name, identification information, an authentication user, date and time, a request, a status, a byte count, a referrer, and a user agent. This example indicates that a user succeeded in access to the page doc3.html from 10.0.51.101 through Microsoft Internet Explorer 6.0 on Windows XP at 17:30:05 on Dec. 25, 2006 in Japan time. It is noted that the source of the link access is the page www.aaa.com/docl.html.

Based on the determined frequencies, access frequencies for every period and source page of which link is followed are provided to the link information table in the index DB 41 in a step S210. Steps S208 to S210 are repeatedly executed until all of the recorded URLs are processed in the same manner (until the determination of a step S211 indicates “Y”), and then the data acquisition process is finished. In this way, the index table shown in FIG. 7 for web pages in the data medium 21 and the link information table shown in FIG. 8 are generated. The index table shows the result of extracting each search word from the five web pages shown in Table 1 as an example.

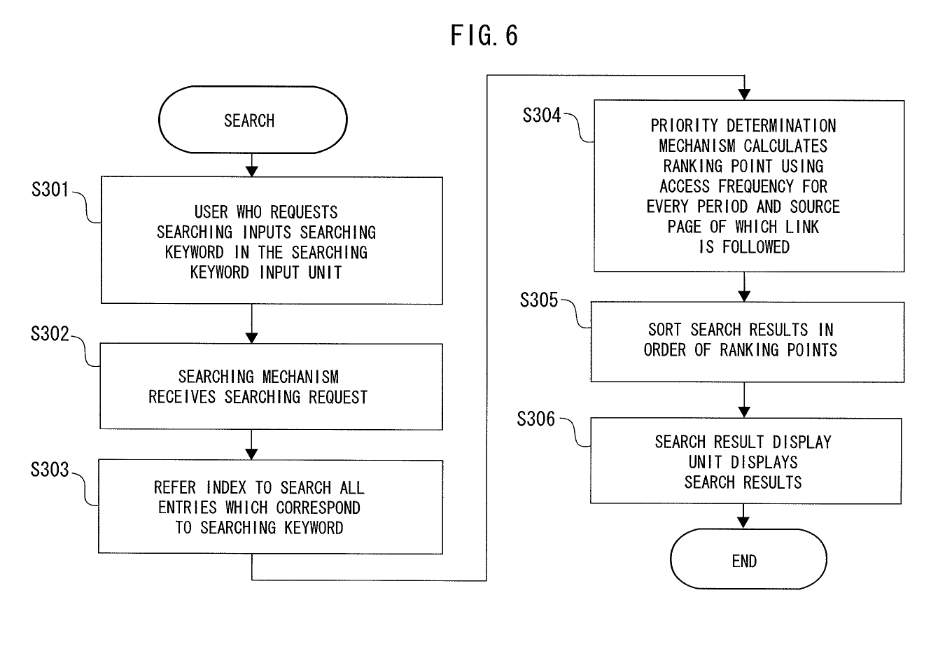

The process when the user who requests searching operates the input/output unit 10 to execute the searching using a predetermined keyword as a searching condition will be explained next based on a flowchart in FIG. 6.

When the user who requests searching inputs a searching keyword in the searching keyword input unit 11 in a first step S301 in the searching process, the searching mechanism 51 receives the searching request in a step S302, and extracts all the entries which correspond to the searching keyword with reference to the index DB 41. For example, when a keyword “search” is input, four web pages are extracted as shown in FIG. 7.

Subsequently, in a step S304, the priority determination mechanism 52 calculates priority (ranking) scores. At this time, the access frequencies for every period and source page of which link is followed for each web page extracted by searching are read out from the link information table in the index DB 41, and the priority scores are calculated. In this example, the access frequencies during the past month are tallied to be used in calculating the priority.

The search results are sorted in score order of the ranking in a step S305, displayed on the search result display unit 12 in a step S306, and the searching process is finished.

To calculate the score of priority, for example, the priority score PR(A) of the page A under the assumption that links are provided to the page A from external pages T1 to Tn, the following expression is used:

PR(A)=(1−d)+d(PR(T1)×(M(A, T1)/A(T1))+ . . . +PR(Tn)×(M(A, Tn)/A(Tn)))

where PR(T1) to PR(Tn) denote the priority scores for the respective external pages, A(T1) to A(Tn) denote the total number of accesses from the respective external pages T1 to Tn to all link destinations including the page A, M(A, T1) to M(A, Tn) denote the access frequencies of the accesses from the respective external pages T1 to Tn to the page A and a dumping factor d denotes a probability of finding a particular web page by following links.

Specific scores are calculated based on the indexes shown in FIG. 7 and the access frequencies shown in FIG. 8 on the assumption of the link relation shown in Table 1. The priority scores for each web page are calculated at first.

Set the web page with entry 0 as the start page and the score PR(doc1)=1. Set the damping factor as d=1. The web page PR(doc2.html) with entry 1 is provided with links only from the external page with entry 0, and the total number of accesses from the external page with entry 0 is 100 while 90 of them are the number of accesses to the web page with entry 1. Therefore, the score of the web page with entry 1 is as follows:

P(doc2)=PR(doc1)×90/100=0.9

The web page (doc3.html) with entry 2 is provided with links from the external pages with entries 0 and 1, and the total number of accesses from the external page with entry 0 is 100 while 10 of them are the number of accesses to the web page with entry 2. The total number of accesses from the external page with entry 1 is 90 while 60 of them are the number of accesses to the web page with entry 2. Therefore, the score of the web page with entry 2 is as follows:

PR(doc3)=PR(doc1)×10/100+PR(doc2)×60/90=0.6

The web page (doc4.html) with entry 3 is provided with a link only from the external page with entry 1, and the total number of accesses from the external page with entry 1 is 90 while 20 of them are the number of accesses to the web page with entry 3. Therefore, the score of the web page with entry 3 is as follows:

PR(doc4)=PR(doc2)×20/90=0.2

The web page (doc5.html) with entry 4 is provided with a link only from the external page with entry 1, and the total number of accesses from the external page with entry 1 is 90 while 10 of them are the number of accesses to the web page with entry 4. Therefore, the score of the web page with entry 4 is as follows:

PR(doc5)=PR(doc2)×10/90=0.1

For example, when searching is executed by inputting a keyword “search”, four web pages are extracted with each entry 0, 1, 2 and 3. The priority scores for these web pages are 1.0, 0.9, 0.6 and 0.2, respectively, and the search results are listed in the following order shown in Table 2.

TABLE 2

| priority | | |
|---|---|---|
| score | Entries | URL of the Web page |
| 1.0 | 0 | www.aaa.com/doc1.html |
| 0.9 | 1 | www.bbb.com/doc2.html |
| 0.6 | 2 | www.ccc.com/doc3.html |
| 0.2 | 3 | www.ddd.com/doc4.html |

Access frequencies of following links may be tallied during a certain period of time in the past as described above, or temporal variation in frequency may be observed to determine priority scores for every predetermined period. The following example which considers temporal variation in access frequency is now described.

In this example, a month is divided into three periods: the period from the first day to the tenth day, the period from the eleventh day to the twentieth day and the period from the twenty-first day to the thirty-first day, so as to tally the access frequencies separately. Such setting is performed to address the frequency variation for, for example, a file having an access frequency which changes through the periods within a month, such that the priority is set higher in one period while the priority is set lower for another period.

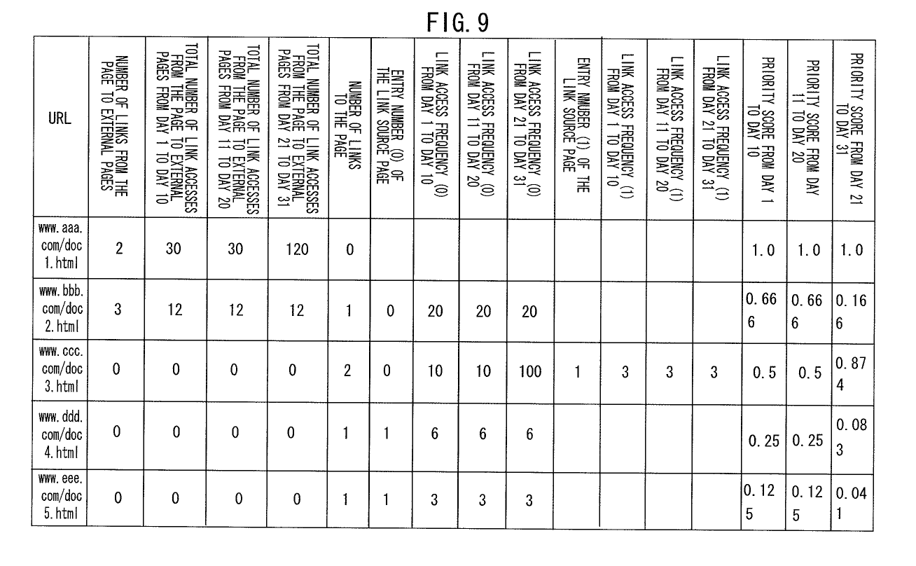

FIG. 9 shows an example of the result of tallying access frequencies by dividing a month into three periods as described above. Since the access frequencies are tallied in this manner, priority scores change depending on the period. The following are the calculation results of the priority scores of web pages with entries 1 to 4 during each period. The link relations are the same as the ones shown in FIG. 1, and the calculation is made using the access frequencies shown in FIG. 9 based on the above mentioned determination expressions including the web page PR(doc1)=1 and the damping factor d=1. Description of each expression will be omitted.

1st day to 10th day

PR(doc2)=PR(doc1)×20/30=0.666

PR(doc3)=PR(doc1)×10/30+PR(doc2)×3/12=0.5

PR(doc4)=PR(doc2)×6/12=0.25

PR(doc5)=PR(doc2)×3/12=0.125

11th day to 20th day

PR(doc2)=PR(doc1)×20/30=0.666

PR(doc3)=PR(doc1)×10/30+PR(doc2)×3/12=0.5

PR(doc4)=PR(doc2)×6/12=0.25

PR(doc5)=PR(doc2)×3/12=0.125

21st day to 31st day

PR(doc2)=PR(doc1)×20/120=0.166

PR(doc3)=PR(doc1)×100/120+PR(doc2)×3/12=0.874

PR(doc4)=PR(doc2)×6/12=0.083

PR(doc5)=PR(doc2)×3/12=0.041

In the above specific example, the search result of the priority scores of four web pages extracted with the keyword “search” are listed in an order as indicated in the following Table 3, when the searching is made on 5th day and on 30th day. It is shown that a priority is higher for the upper column in Table 3. Since the access frequency to the web page www.ccc.com/doc3.html from the page www.aaa.com/doc1.html has a high priority score during the period from 21st day to 31st day, the priority score of the former page is set high when searching is made on 30th.

TABLE 3

| search on the 5th day | | search on the 30^{th} day | |
|---|---|---|---|
| score | URL | score | URL |
| 1.0 | www.aaa.com/doc1.html | 1.0 | www.aaa.com/doc1.html |
| 0.666 | www.bbb.com/doc2.html | 0.874 | www.ccc.com/doc3.html |
| 0.5 | www.ccc.com/doc3.html | 0.166 | www.bbb.com/doc2.html |
| 0.25 | www.ddd.com/doc4.html | 0.083 | www.ddd.com/doc4.html |

What is claimed is:

1. A computer readable recording medium which stores a web page searching program which causes a computer to function as a web page searching apparatus for searching web pages publicized on a network by web servers,
wherein the web page searching program causes the computer to function as:
searching means for extracting from the pages being searched, a web page associated with a keyword which is a searching condition inputted, based on the keyword; and
prioritizing means for referring to access log files which are stored in the web server corresponding to the extracted web page and record, for every user accessing, information about which page's link is followed to access the web page by the user, tallying for each link provided to the web page the accesses to the web page by following links to calculate an access frequency, determining a priority of the extracted web page for display by considering the calculated access frequency, and assigning the determined priority.

2. The computer readable recording medium which stores the web page searching program according to claim 1, wherein the prioritizing means, when determining a priority of a specific page under the assumption that links are provided to the specific page from a plurality of external pages, determines for each external page, a quotient value by dividing the product of the priority of the external page and the access frequency from the external page to the specific page by the total number of accesses from the external page to all of the link destinations including the specific page, and multiplies the sum of the quotient values for all the external pages and a probability of finding the specific web page by following the links, and adds the resultant product value and a probability of finding the specific web page without following any link so that the resultant sum is the priority of the specific page.

3. The computer readable recording medium which stores the web page searching program according to claim 1, wherein the prioritizing means classifies and manages the access frequencies to the web page in a temporal order.

4. A web page searching method which searches web pages publicized on a network by web servers, wherein a computer performs procedure comprising:
a searching procedure for extracting from the pages being searched, a web page associated with a searching keyword which is a searching condition inputted, based on the keyword; and
a prioritizing procedure for referring to access log files which are stored in the web server corresponding to the extracted web page and recording, for every user accessing, information about which page's link is accessed by the user, tallying for each link access to the web page to calculate an access frequency, determining a priority of the extracted web page for display by considering the calculated access frequency, and assigning the determined priority.

5. The web page searching method according to claim 4, wherein the prioritizing procedure, when determining a priority of a specific page under the assumption that links are provided to the specific page from a plurality of external pages, determines, for each external page, a quotient value by dividing the product of the priority of the external page and the access frequency from the external page to the specific page by the total number of accesses from the external page to all of the link destinations including the specific page, and multiplies the sum of the quotient values for all the external pages and a probability of finding the specific web page by following the links, and adds the resultant product value and a probability of finding the specific web page without following any link so that the resultant sum is the priority of the specific page.

6. The web page searching method according to claim 4, wherein the prioritizing procedure classifies and manages the access frequencies to the web page in a temporal order.

7. A web page searching apparatus which searches web pages publicized on a network by web servers comprising:
searching means for extracting from the pages being searched, a web page associated with a searching keyword which is a searching condition inputted based on the keyword; and
prioritizing means for providing a priority to the extracted web page for display,
wherein the prioritizing means refers to access log files which are stored in the web server corresponding to the extracted web page and records, for every user accessing, information about which page's link is followed to access the web page by the user, tallies for each link provided to the web page the accesses to the web page by following links to calculate an access frequency, and considers the calculated access frequency in determination of the priority.

8. The web page searching apparatus according to claim 7, wherein the prioritizing means, when determining a priority of a specific page under the assumption that links are provided to the specific page from a plurality of external pages, determines for each external page, a quotient value by dividing the product of the priority of the external page and the access frequency from the external page to the specific page by the total number of accesses from the external page to all of the link destinations including the specific page, and multiplies the sum of the quotient values for all the external pages and a probability of finding the specific web page by following the links, and adds the resultant product value and a probability of finding the specific web page without following any link so that the resultant sum is the priority of the specific value.

9. The web page searching apparatus according to claim 7, wherein the prioritizing means classifies and manages the access frequencies to the web page in a temporal order.
